(19) United States
(12) Patent Application Publication
(10) Pub. No.: US 2023/0242217 A1
(43) Pub. Date: Aug. 3, 2023

(54) VEHICLE WITH TRACK LUBRICATION SYSTEM

(71) Applicant: BOMBARDIER RECREATIONAL PRODUCTS INC., Valcourt (CA)

(72) Inventors: Xavier-Pierre Aitcin, St-Hyacinthe (CA); Thomas Parent-Simard, Sherbrooke (CA)

(21) Appl. No.: 18/159,594

(22) Filed: Jan. 25, 2023

Related U.S. Application Data
(60) Provisional application No. 63/304,590, filed on Jan. 29, 2022.

(51) Int. Cl. B62M 27/02; B62D 55/092

(52) U.S. Cl. CPC B62M 27/02; B62D 55/092; B62M 2027/027; B62D 55/065

(57) ABSTRACT

A vehicle, including a chassis; at least one seat connected to the chassis; a motor connected to the chassis; an endless drive track disposed at least in part below the chassis, the endless drive track being operatively connected to the motor for propulsion of the vehicle; a suspension assembly supporting the endless drive track and including slide rails; and a drive track lubrication system connected to the chassis. The system includes a lubricant tank and at least one conduit positioned and arranged to deliver lubricant from the lubricant tank to at least a portion of an interior side of the endless drive track, the lubricant delivered providing lubrication at least partially between the interior side of the endless drive track and the slide rails.

### CROSS-REFERENCE

The present application claims priority to U.S. Provisional Patent Application No. 63/304,590, entitled “Vehicle with Track Lubrication System,” filed Jan. 29, 2022, the entirety of which is incorporated by reference herein.

### FIELD OF TECHNOLOGY

The present technology relates generally to vehicles with endless tracks, and more specifically vehicles with endless track lubrication systems.

### BACKGROUND

Recreational vehicles, such as snowmobiles, are often provided with endless tracks for travel on a variety of surfaces and terrains, rough and smooth, soft and rigid, level, and inclined upwards or inclined downwards. Assemblies for supporting the endless tracks often include slide rails in sliding contact with an interior surface of the endless track. The slide rails generally include plastic slides on a bottom surface thereof for providing a sliding surface of the slide rails.

Friction between the track and the slide rails can in some cases partially soften or melt the plastic slides. When this happens, friction can increase further and/or the slides may tend to stick to the track. In this event, significant increases in friction can occur, increasing the energy required to propel the vehicle forward. When subsequently stopping the vehicle, the slides may also cool and further stick to the track and in some cases even prevent the vehicle from moving again without user intervention. For some vehicles, for example having with low horsepower engines or electric motors, even a slight increase in friction could negatively impact the efficiency or autonomy of the vehicle.

In some cases, some lubrication could be provided by snow, for example while travelling over a hard pack trail or a frozen lake. One proposed solution to reduce friction is to use “scratchers” which are attached to the vehicle and can be lowered to “scratch” the surface of the ground to propel snow and ice crystals onto the track between the slides and the track. While effective in some situations to decrease friction between the slides and the track, the scratchers increase friction with the ground.

Therefore, there is a desire for solutions for reducing friction within endless track systems.

### SUMMARY

It is an object of the present technology to ameliorate at least some of the inconveniences present in the prior art.

In according to aspects of the present technology, there are provided systems for selectively providing lubrication between slide rails and the interior side of the endless track to aid in decreasing friction and sticking therebetween. Lubricant is selectively delivered, from a lubricant tank, by one or more conduits to the interior side of the endless track. The lubricant, depending on the embodiment, can be delivered to the track forward of the slide rails and/or through passages defined in various portions of the slide rails. In some cases, the lubricant can be caused to be delivered to the track by manual activation, for instance using a bulb pump. In some other cases, a manual actuator like a switch could selectively cause a pump to pump the lubricant to the track. A controller could also be included to perform automatic detection of sticking between the slide rails and the track, in order to perform automated lubrication of the track.

In according to one aspect of the present technology, there is provided a vehicle, including a chassis; at least one seat connected to the chassis; a motor connected to the chassis; an endless drive track disposed at least in part below the chassis, the endless drive track being operatively connected to the motor for propulsion of the vehicle; a suspension assembly supporting the endless drive track, the suspension assembly comprising: a left slide rail; a right slide rail; at least one suspension arm pivotally connected to one of the left and right slide rails and pivotally connected to the chassis; a shock absorber connected between the chassis and the one of the left and right slide rails; and a drive track lubrication system connected to the chassis. The system includes a lubricant tank supported by the chassis; and at least one conduit fluidly connected to the lubricant tank at a first end, a second end of the at least one conduit being positioned and arranged to deliver lubricant from the lubricant tank to at least a portion of an interior side of the endless drive track, the lubricant delivered providing lubrication at least partially between the interior side of the endless drive track and the left and right slide rails.

In some embodiments, at least one slide rail of the left slide rail and the right slide rail has at least one lubricant passage defined therethrough; the second end of the at least one conduit is fluidly connected to a first opening of the at least one lubricant passage; and a second opening of the at least one lubricant passage is defined on a lower surface of the at least slide rail such that lubricant passing through the at least one lubricant passage is delivered to the interior side of the endless drive track.

In some embodiments, the at least one lubricant passage is at least one first lubricant passage and at least one second lubricant passage; the at least one first lubricant passage is defined in the right slide rail; the at least one conduit includes at least one first conduit and at least one second conduit; the at least one first conduit is fluidly connected to the at least one first lubricant passage; the left slide rail has the at least one second lubricant passage defined therethrough; and the at least one second conduit is fluidly connected to the at least one second lubricant passage.

In some embodiments, the at least one first lubricant passage includes a first forward lubricant passage and a first rearward lubricant passage; the first rearward lubricant passage is defined in a portion of the right slide rail rearward of the first forward lubricant passage; the at least one second lubricant passage includes a second forward lubricant passage and a second rearward lubricant passage; and the second rearward lubricant passage is defined in a portion of the left slide rail rearward of the second forward lubricant passage.

In some embodiments, the at least one slide rail further has at least one groove defined in a bottom surface thereof; and the at least one groove extending at least rearward from and being fluidly connected to the at least one lubricant passage.

In some embodiments, the drive track lubrication system further includes a manual lubrication actuator fluidly connected to the lubricant tank; and the manual lubrication actuator is arranged to be accessible to an operator of the vehicle during use.

In some embodiments, the manual lubrication actuator includes a bulb pump supported by the chassis at least partially forward of the at least one seat.

In some embodiments, the vehicle further includes a handlebar connected to the chassis; and the manual lubrication actuator is disposed on the handlebar.

In some embodiments, the drive track lubrication system further includes a pump fluidly connected to the lubricant tank and the at least one conduit; and the manual lubrication actuator includes a switch communicatively connected to the pump for selectively actuating the pump.

In some embodiments, the switch is arranged to be accessible to an operator of the vehicle during use.

In some embodiments, the vehicle further includes a handlebar connected to the chassis; and the switch is disposed on the handlebar.

In some embodiments, the vehicle further includes a controller supported by the chassis; and the drive track lubrication system further includes a pump fluidly connected to the lubricant tank and the at least one conduit, and the pump is communicatively connected to the controller, the controller being configured to control delivery of the lubricant from the lubricant tank to the at least one conduit by the pump.

In some embodiments, the vehicle further includes at least one sensor communicatively connected to the controller; and the controller is further configured to control delivery of the lubricant from the lubricant tank to the at least one conduit by the pump based on information from the at least one sensor.

In some embodiments, the chassis includes a tunnel, the rear suspension assembly being connected the tunnel.

In some embodiments, the vehicle is a snowmobile; and the vehicle further includes a front right ski connected to a front right portion of the chassis; and a front left ski connected to a front left portion of the chassis.

In according to another aspect of the present technology, there is provided a method for lubricating an endless track in a vehicle, the method being performed by a controller of the vehicle. The method includes receiving, from at least one sensor of the vehicle, at least one indication related to operation of the vehicle; and in response to the at least one indication, causing lubricant from a lubricant tank of the vehicle to be delivered to an interior side of the endless track.

In some embodiments, receiving the at least one indication includes at least one of: receiving an activation indication from an actuator of the vehicle; receiving an energy consumption indication from a motor sensor of the vehicle; receiving an inclination indication from an orientation sensor; receiving a speed indication from a speed sensor of the vehicle; and determining at least one environmental condition.

In some embodiments, the method further includes determining, based on the at least one indication, that the endless track has surpassed a threshold sticking indication related to a level of friction between the interior side of the endless track and at least one slide rail of the vehicle.

In some embodiments, causing the lubricant from the lubricant tank to be delivered to the interior side of the endless track includes causing a pump fluidly connected to the lubricant tank to pump the lubricant through a conduit arranged to deliver the lubricant to the interior side of the endless track.

In according to yet another aspect of the present technology, there is provided a drive track lubrication system for a vehicle with an endless track. The system includes a lubricant tank arranged to be connected to a chassis of the vehicle; and at least one conduit fluidly connected to the lubricant tank at a first end, a second end of the at least one conduit being configured for connecting to the vehicle in a position to deliver lubricant from the lubricant tank to at least a portion of an interior side of the endless drive track, the lubricant delivered being configured to provide lubrication between the interior side of the endless drive track and at least one slide rail of the vehicle.

In some embodiments, the system further includes a pump fluidly connected between the lubricant tank and the at least one conduit.

In some embodiments, the system further includes a manual actuator operatively connected to the lubricant tank and the at least one conduit, the manual actuator being configured for causing the lubricant to flow from the tank to the at least one conduit.

In some embodiments, the system further includes a pump fluidly connected between the lubricant tank and the at least one conduit; and the manual actuator is a switch configured for connecting to the vehicle, and the switch is communicatively connected to the pump.

In according to yet another aspect of the present technology, there is provided a vehicle including a chassis; at least one seat connected to the chassis; a motor connected to the chassis; at least one endless drive track disposed at least in part below the chassis, the at least one endless drive track being operatively connected to the motor for propulsion of the vehicle; a suspension assembly supporting the endless drive track, the suspension assembly including at least one slide rail; and at least one suspension arm pivotally connected to the at least one slide rail and pivotally connected to the chassis; a drive track lubrication system connected to the chassis. The system includes a lubricant tank supported by the chassis; and at least one conduit fluidly connected to the lubricant tank at a first end, a second end of the at least one conduit being positioned and arranged to deliver lubricant from the lubricant tank to at least a portion of an interior side of the at least one endless drive track, the lubricant delivered providing lubrication at least partially between the interior side of the at least one endless drive track and the at least one slide rail.

In some embodiments, the at least one slide rail has at least one lubricant passage defined therethrough; the second end of the at least one conduit is fluidly connected to a first opening of the at least one lubricant passage; and a second opening of the at least one lubricant passage is defined on a lower surface of the at least slide rail such that lubricant passing through the at least one lubricant passage is delivered to the interior side of the at least one endless drive track.

In some embodiments, the at least one lubricant passage includes a forward lubricant passage and a rearward lubricant passage; and the rearward lubricant passage is defined in a portion of the at least one slide rail rearward of the forward lubricant passage.

In some embodiments, the at least one slide rail further has at least one groove defined in a bottom surface thereof; and the at least one groove extending at least rearward from and being fluidly connected to the at least one lubricant passage.

In some embodiments, the drive track lubrication system further includes a manual lubrication actuator fluidly connected to the lubricant tank; and the manual lubrication actuator is arranged to be accessible to an operator of the vehicle during use.

In some embodiments, the drive track lubrication system further includes a pump fluidly connected to the lubricant tank and the at least one conduit; and the manual lubrication actuator includes a switch communicatively connected to the pump for selectively actuating the pump.

In some embodiments, the vehicle further includes a controller supported by the chassis; and the drive track lubrication system further includes a pump fluidly connected to the lubricant tank and the at least one conduit, and the pump is communicatively connected to the controller, the controller being configured to control delivery of the lubricant from the lubricant tank to the at least one conduit by the pump.

For purposes of the present application, terms related to spatial orientation when referring to the vehicle and components in relation to the vehicle, such as “forward”, “rearward”, “left”, “right”, “above” and “below”, are as they would be understood by a user of the vehicle sitting thereon in a normal riding position, with the vehicle in a straight ahead orientation (i.e. not steered left or right), and in an upright position (i.e. not tilted). When referring to a component alone, terms related to spatial orientation are described with respect to the component as disposed on the vehicle.

The explanations provided above regarding the above terms take precedence over explanations of these terms that may be found in any one of the documents incorporated herein by reference.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a snowmobile according to one embodiment of the present technology;

FIG. 2 is a top, rear, left side perspective view of portions of a chassis and a rear suspension assembly of the snowmobile of FIG. 1;

FIG. 3 is a close-up, partial view of a handlebar assembly of the snowmobile of FIG. 1;

FIG. 4 is a right side elevation view of the rear suspension assembly, portions of an endless track, and a track lubrication system of the snowmobile of FIG. 1;

FIG. 5 is a cross-sectional view of portions of the rear suspension assembly, portions of the endless track, and the track lubrication system of the snowmobile of FIG. 1, taken along line 5-5 of FIG. 4;

FIG. 6 is a close-up view of the rear suspension assembly, endless track, and track lubrication system of FIG. 5, taken from figure portion 6 of FIG. 5;

FIG. 7 is a right side elevation view of another non-limiting embodiment of a rear suspension assembly, portions of an endless track, and a track lubrication system usable with the snowmobile of FIG. 1;

FIG. 8 is a right side elevation view of yet another non-limiting embodiment of a rear suspension assembly, portions of an endless track, and a track lubrication system usable with the snowmobile of FIG. 1;

FIG. 9 is a right side elevation view of yet another non-limiting embodiment of a tunnel, a rear suspension assembly, portions of an endless track, and a track lubrication system usable with the snowmobile of FIG. 1;

FIG. 10 is a right side elevation view of yet another non-limiting embodiment of a rear suspension assembly, portions of an endless track, and a track lubrication system usable with the snowmobile of FIG. 1;

FIG. 11 is a perspective view, taken from a front, right side, of a side-by-side vehicle (SSV) provided with track assemblies;

FIG. 12 is a right side elevation view the vehicle of FIG. 10; and

FIG. 13 illustrates a flowchart for a method of operating the track lubrication system of FIG. 10.

Figures may not be drawn to scale.

### DETAILED DESCRIPTION

Although the present technology is described below mainly with respect to a snowmobile 10, it is contemplated that aspects could be applied to other vehicles with suspensions and assemblies supporting an endless track, including, but not limited to all-terrain vehicles (ATVs). Applications of the present technology to side-by-side vehicles (SSVs) is described further below.

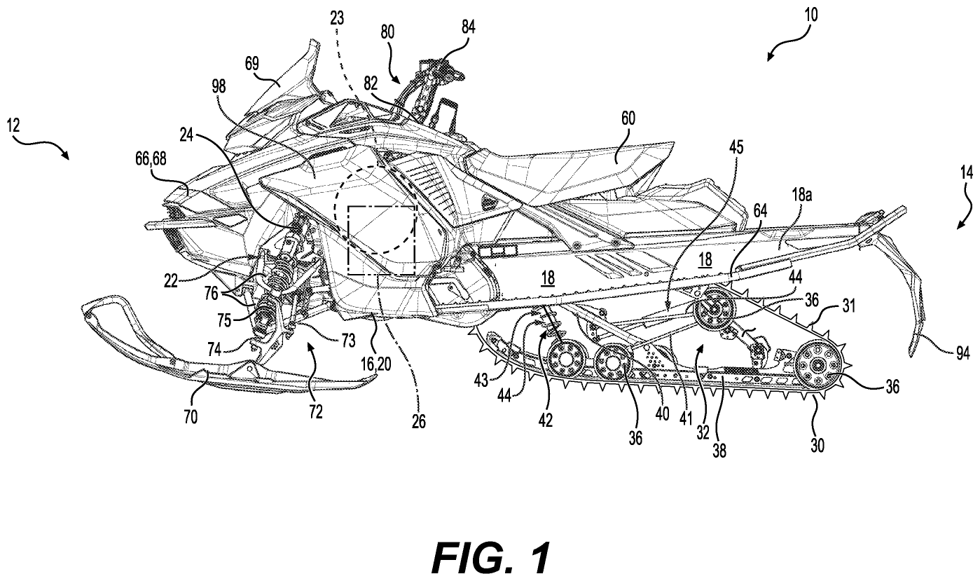

With reference to FIG. 1, the snowmobile 10 includes a front end 12 and a rear end 14 which are defined consistently with a travel direction of the vehicle 10. The snowmobile 10 includes a vehicle body in the form of a frame or chassis 16 which includes a rear tunnel 18, a motor module 20, a front suspension module 22 and an upper structure 24. The tunnel 18 is formed from sheet metal parts assembled to form an inverted U-shape when viewed from the front or rear end 12, 14. The inverted U-shaped tunnel 18 has a left side portion 18a and a right side portion 18a (only the left being shown).

A motor 26, schematically illustrated, is carried in a motor compartment defined by the motor module 20 of the chassis 16 and provides, in part, propulsion of the snowmobile 10. In the illustrated embodiment, the motor 26 is an internal combustion engine 26, but it is contemplated that it could be, for example, an electric motor or a hybrid.

An endless drive track 30 is positioned generally under the tunnel 18 and is operatively connected to the motor 26 via a drivetrain including a belt transmission system (not shown). The endless drive track 30 is driven to run about a rear suspension assembly 32 connected to the chassis 16 for propulsion of the snowmobile 10. The endless drive track 30 has a plurality of lugs 31 extending from an outer surface thereof to provide traction to the track 30.

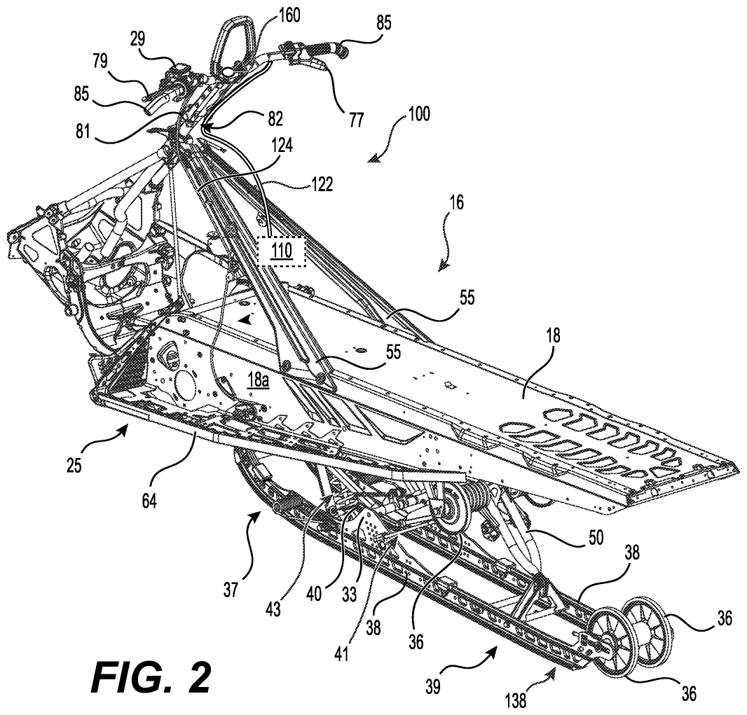

With additional reference to FIG. 2, the rear suspension assembly 32 includes multiple idler wheels 36 and a pair of slide rails 38 in sliding contact with the endless drive track 30. The drive axle 35 having the drive sprockets 34 mounted thereon defines a drive axle axis 34a. The slide rails 38 are attached to the tunnel 18 by a front suspension arm 40 and a rear suspension arm 50. A front shock absorber assembly 42, including a coil spring 43 surrounding an individual shock absorber 44 and a rear shock absorber 45 with adjacent torsion springs 41 bias the slide rails 38 away from the tunnel 18.

The tunnel 18 is supported by the front and rear suspension arms 40, 50. The pivoting of the suspension arms 40, 50 changes the relative angle and vertical separation between the slide rails 38 and the tunnel 18 to enable a transfer of weight to the front end 12 or the rear end 14 of the snowmobile 10 as would be appropriate for the travel speed and terrain, for example, during travel on inclined surfaces. The pivoting of the suspension arms 40, 50 also aids in bump absorption as the snowmobile 10 travels over uneven or rough terrain. It is contemplated that the snowmobile 10 could be provided with a different embodiment of a rear suspension assembly 32 than the one shown herein.

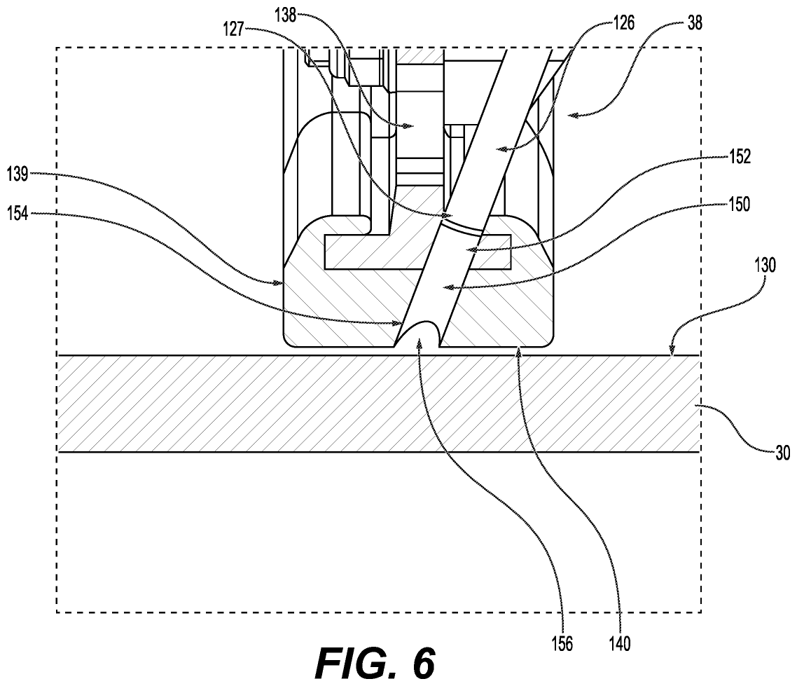

The pair of slide rails 38 includes a left slide rail 38 and a right slide rail 38. Each slide rail 38 includes a front portion 37 and rear portion 39. The slide rails 38 are connected to pairs of rear idler wheels 36 engaging the endless track 30 at the front 37 and rear 39 portions of the slide rails 38. Each slide rail 38 is formed from a slide rail body 138 and a slider 139 connected and enveloping a bottom side of the slide rail body 139 (see FIG. 6). The slider 139 is formed from plastic and provides a bottom sliding surface 140 for being in sliding contact with an interior side 130 of the endless track 30. It is contemplated that in some embodiments, the slider 139 could be omitted and the slide rail body 138 could form the bottom surface 140 of the slide rail 38. Additional details of the left and right slide rails 38 are described below.

Returning to FIG. 1, a straddle seat 60 is positioned atop the chassis 16. The seat 60 is adapted to accommodate the user of the snowmobile 10. The seat 60 can also be configured to accommodate a passenger. A footrest 64 is positioned on each side of the snowmobile 10 below the seat 60 to accommodate the user's feet. Each of the left and right footrests 64 extends generally laterally outwardly from the corresponding left- and right-side portion of the tunnel 18. In the illustrated embodiment, each side portion 18a of the tunnel 18 is bent laterally outwardly at its bottom edge to form the corresponding footrest 64. It is however contemplated that the footrest 64 could be formed separately from and mounted to the tunnel 18.

At the front end 12 of the snowmobile 10, body panels 66 enclose the engine 26, the continuous variable transmission system 23 and other components of the powerpack such as the air intake system. The body panels 66 include a hood 68 which can be removed/opened to allow access to the engine 26 and other internal components of the snowmobile 10 from the top and the front which may be required, for example, for inspection or maintenance of the motor 26 and/or the powerpack. The body panels 66 also include two side panels 98 extending along the left and right sides of the snowmobile 10. The motor 26 and the transmission system 23 are disposed between the side panels 98. The side panels 98 are both removably connected to the chassis 16 and/or to other body panels 66 and can be removed/opened to access the internal components from the corresponding lateral side. A windshield 69 connected to the body panels 66 acts as a wind screen to lessen the force of the air on the user while the snowmobile 10 is moving.

Two skis 70 positioned at the forward end 12 of the snowmobile 10 are attached to the front suspension module 22 of the chassis 16 through a front suspension assembly 72. The front suspension module 22 is connected to the front end of the engine module 20. The front suspension assembly 72 includes ski legs 74, shock absorbers 75, supporting arms 76 and ball joints (not shown) for operatively connecting to the respective ski leg 74, supporting arms 76 and a steering column 82.

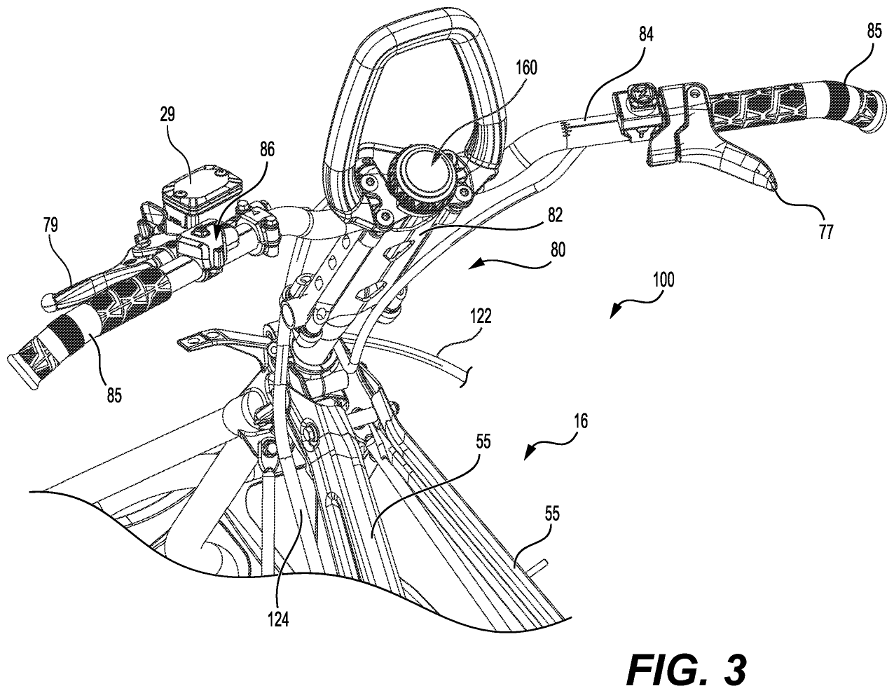

With additional reference to FIG. 3, a steering assembly 80 is provided generally forward of the seat 60. The steering assembly 80 includes the steering column 82 and a handlebar 84. The steering column 82 is rotatably connected to the chassis 16, including by two frame members 55 extending from the steering column 82 to the tunnel 18. The lower end of the steering column 82 is connected to the ski legs 74 via steering rods 73 (FIG. 1). The handlebar 84 is attached to the upper end of the steering column 82. The handlebar 84 is positioned in front of the seat 60. The handlebar 84 is used to rotate the steering column 82, and thereby the skis 70, in order to steer the vehicle 10. A left handle 85 and a right handle 85 are disposed on left and right sides of the handlebar 84 respectively. A throttle operator 77 in the form of a thumb-actuated throttle lever is mounted to the right side of the handlebar 84. Other types of throttle operators, such as a finger-actuated throttle lever, are also contemplated. A brake actuator 79, in the form of a hand brake lever 79, is provided on the left side 83 of the handlebar 84 for braking the snowmobile 10 in a known manner. A right end of the brake lever 79 connects to a brake fluid reservoir 29 connected to the handlebar 84 rightward of the handle 85. It is contemplated that the windshield 69 could be connected directly to the handlebar 84.

At the rear end 14 of the snowmobile 10, a snow flap 94 extends downward from the rear end of the tunnel 18 (FIG. 1). The snow flap 94 protects against snow and/or debris that can be projected rearward from the drive track 30 when the snowmobile 10 is being driven. The snow flap 94 also projects snow onto a heat exchanger that is used to cool liquid for cooling the motor 26.

The snowmobile 10 includes other components such as a display cluster, an exhaust system, an air intake system, and the like. As it is believed that these components would be readily recognized by one of ordinary skill in the art, further explanation and description of these components will not be provided herein. Additional details pertaining to a snowmobile similar to the snowmobile 10 can be found in U.S. Pat. No. 11,235,634, issued Feb. 1, 2022, the entirety of which is incorporated herein by reference.

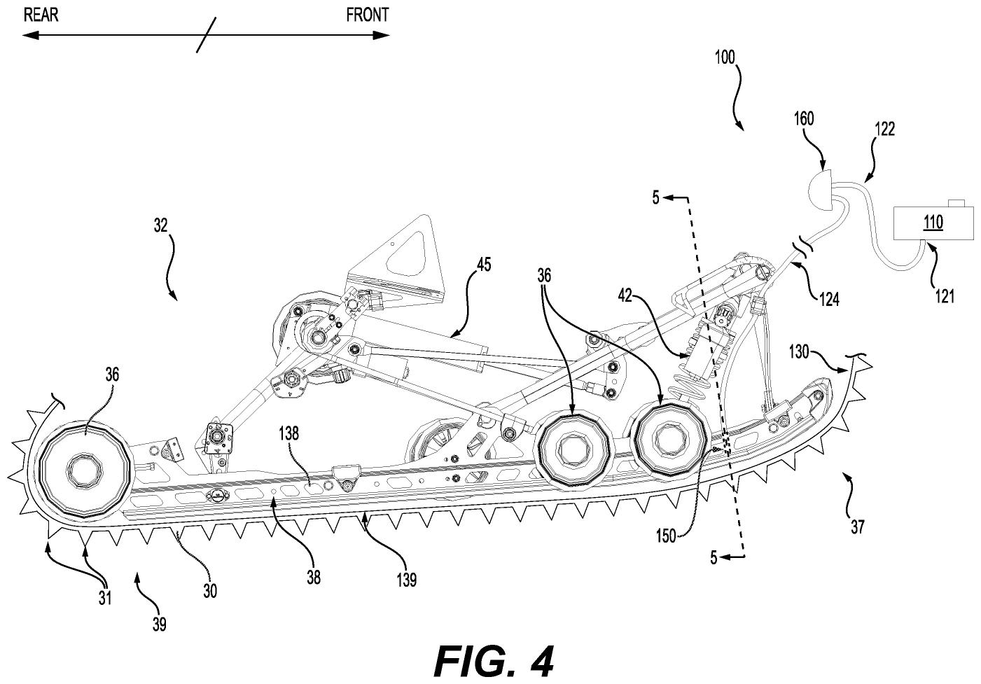

With continued reference to FIGS. 2 and 3, and additional reference to FIG. 4, the snowmobile 10 according to the present technology includes a drive track lubrication system 100 for selectively providing lubrication between the slide rails 38 and the endless drive track 30. As will be described in more detail below, the system 100 selectively provides lubricant to the endless track 30 to aid in decreasing friction and/or sticking between the slide rails 38 and the endless track 30. The system 100 is generally supported by and connected to the chassis 16. In some embodiments, the drive track lubrication system 100 could be provided as a system kit to be installed in a snowmobile not previously provided with the drive track lubrication system 100.

The drive track lubrication system 100 includes a lubricant tank 110 supported by the chassis 16. The tank 110 is illustrated schematically as being supported by the frame members 55 above a forward portion of the tunnel 18, but the particular placement of the tank 110 could vary. The lubricant tank 110 is configured to receive and store lubricant to be selectively delivered to the track 30 (described further below). The particular lubricant to be used is not specifically limited and could depend on different details of the embodiment. The lubricant could depend on different parameters, including the track material, slide rail 38 material(s), local regulations, and/or environmental conditions. The lubricant could include, but is not limited to, grease, oil and powder.

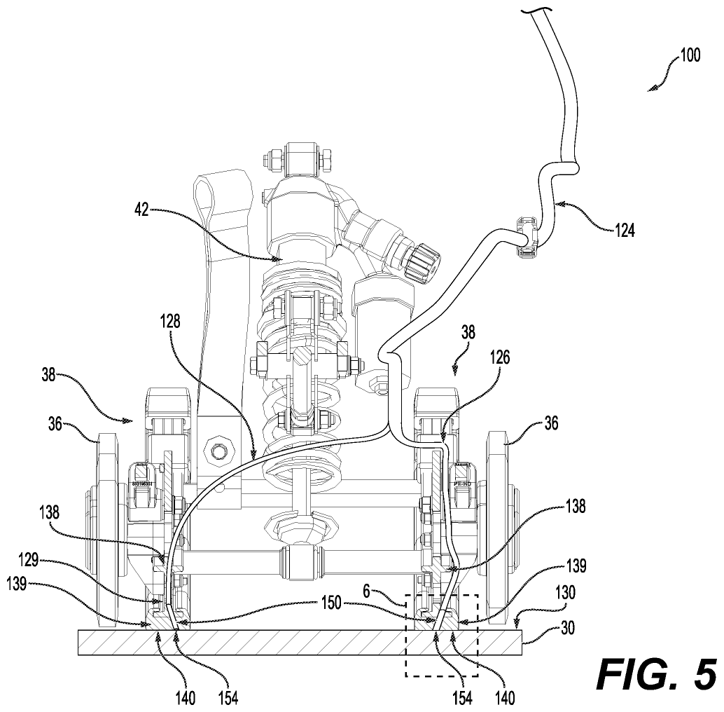

The system 100 includes conduits fluidly connected to the lubricant tank 110 for delivering lubricant from the tank 110 to the endless drive track 30. A first end 121 of a first conduit 122 is fluidly connected to the tank 110. The conduit 122 is fluidly connected to an intermediate conduit 124, via a bulb pump 160 (described further below). A bottom end of the conduit 124 is fluidly connected to two lower conduits 126, 128 (FIG. 5). A bottom end 127 of the conduit 126 and a bottom end 129 of the conduit 128 are positioned and arranged to deliver lubricant from the lubricant tank 110 to at least a portion of an interior side of the endless drive track 30.

Specifically, as seen in FIG. 5, the conduit bottom ends 127, 129 are fluidly connected to lubricant passages 150 defined in each of the slide rails 38. Each slide rail 38 includes at least one lubricant passage 150, one lubricant passage 10 being defined in a generally forward portion of the slide rail 38 in the present embodiment. As shown in FIG. 6 for the left slide rail 38, the conduit bottom ends 127, 129 are fluidly connected to a top opening 152 of each the lubricant passages 150. Each slide rail 38 also has a bottom opening 154 of the passage 150 defined on a lower surface 140 of each slide rail 38, such that lubricant passing through the lubricant passage 150 is delivered to the interior side 130 of the endless drive track 30. As can be seen in FIG. 6, the passage 150 is defined through the slide rail body 138 and the slider 139. In some embodiments, it is contemplated that the slider 139 could be omitted. In such cases, the passages 150 could be defined entirely by the slide rail body 138. It is also contemplated that the passages 150 could be defined entirely by the slider 139.

Although both slide rails 38 are illustrated with lubricant passages 150 defined therein, it is contemplated that only one of the slide rails 38 could be provided with the passages 150 therein. It is also contemplated that both slide rails 38 could be formed with the passages 150, but the corresponding conduits could be connected to only one of the passages 150.

To aid in spreading the lubricant over the track interior side 130, each slide rail 38 further has a groove 156 defined in the bottom surface 140. As can be seen in FIG. 6, the groove 156 is specifically defined in the slider 139. It is contemplated that in some embodiments the slider could be omitted, and the groove 156 could be defined in the slide rail body 138 itself. The grooves 156 extend generally longitudinally rearward from and are fluidly connected to the lubricant passages 150.

The lubricant delivered provides lubrication at least partially between the interior side 130 of the endless drive track 30 and the left and right slide rails 38. As the track 30 turns, lubricant is pulled rearward and spread across at least some portions of the space between the bottom surface 140 of the rails 38 and the track interior side 130. Over multiple cycles of the track 30 sliding under the slide rails 38, the lubricant generally will also spread laterally, beyond the grooves 156. The specific profile of lubricant thickness across the track interior side 130 could vary depending different arrangements of delivery of the lubricant to the track interior side 130.

The drive track lubrication system 100 further includes a manual lubrication actuator 160 fluidly connected to the lubricant tank 110 for selectively causing lubricant to flow from the lubricant tank 110. The actuator 160 is arranged to be accessible to an operator of the vehicle 10 during use, such that the user can selectively control lubricant delivery to the track 30. As can be seen in FIGS. 2 and 3, the actuator 160 in the illustrated embodiment is specifically a bulb pump 160 supported by the chassis 16, forward the seat 60. The bulb pump 160 is disposed on a central portion of the handlebar 84, although the specific placement of the bulb pump 160 on the handlebar 84 could vary. It is also contemplated that the bulb pump 160 could be disposed elsewhere on the vehicle 10.

The bulb pump 160 is fluidly connected to the tank 110 via the conduit 122. The conduit 124 is in turn fluidly connected to the bulb pump 160. By applying and releasing pressure to the bulb pump 160, lubricant is caused to flow from the tank 110 into the conduit 122, through the bulb pump 160, and into the conduit 124.

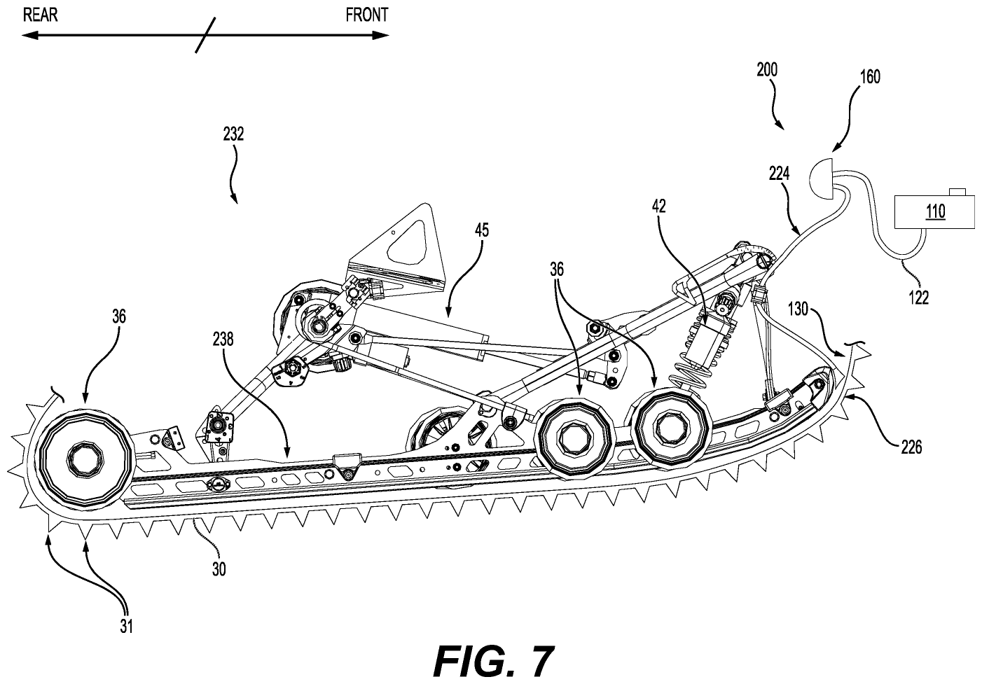

Another embodiment of a track lubricant system 200 and a suspension assembly 232 according to the present technology are illustrated in FIG. 7. Elements of the track lubricant system 200 and the suspension assembly 232 that are similar to those of the track lubricant system 100 and the suspension assembly 32 retain the same reference numeral and will generally not be described again.

The suspension assembly 232 includes slide rails 238 which have no lubricant passages defined therein. It is contemplated that the lubrication system 200 could be used with the slide rails 38, having the passages 150 defined therein, in at least some embodiments.

The system 200 includes a conduit 224 fluidly connected to the lubricant tank 110, via the bulb pump 160 and the conduit 122. A bottom end 226 of the conduit 224 is positioned and arranged to deliver lubricant from the lubricant tank 110 to at least a portion of the interior side 130 of the endless drive track 30. The bottom end 226 of the conduit 224 delivers lubricant forward of the slide rails 238. As the track 30 turns, during use, the lubricant is pulled under the bottom surface 140 of the slide rails 238 to provide lubrication between the slide rails 238 and the track interior side 130. In at least some embodiments, the bottom end 226 could include a nozzle shaped for spraying the lubricant over at least some lateral width of the track interior side 130. It is also contemplated that two or more conduits could be connected to the conduit 224 for delivering lubricant to different points of the track 30 forward of the slide rails 238.

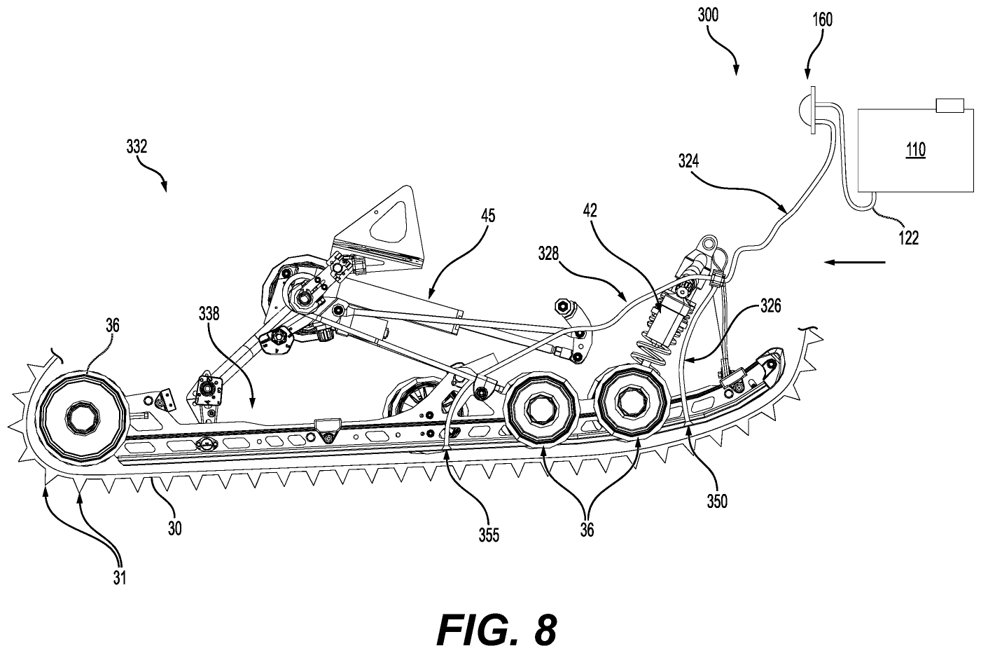

With reference to FIG. 8, yet another embodiment of a track lubrication system 300 and a suspension assembly 332 are illustrated. Elements of the track lubricant system 300 and the suspension assembly 332 that are similar to those of the track lubricant system 100 and the suspension assembly 32 retain the same reference numeral and will generally not be described again.

The suspension assembly 332 includes two slide rails 338 (only the right slide rail 338 being shown), with each including two lubricant passages defined therein. The slide rails 338 are otherwise similar to the slide rails 38. A forward lubricant passage 350 is defined in a forward portion of the slide rail 338. A rearward lubricant passage 355 is defined in a portion of the slide rail 338 rearward of the forward lubricant passage 355. Each of the passages 350, 355 are disposed on opposite sides of the front idler wheels 36. Depending on the embodiment, the passages 350, 355 could be arranged at different lateral locations across the slide rails 338.

The track lubrication system 300 includes a conduit 324 fluidly connected to the lubricant tank 110, via the bulb pump 160 and the conduit 122. The system 300 further includes two conduits 326, each being fluidly connected between the conduit 324 and one of the forward lubricant passages 350. Two conduits 328 are also included, each conduit 328 being fluidly connected between the conduit 324 and one of the rearward lubricant passages 355. It is contemplated that additional passages and conduits could be used for distributing the lubricant over different portions of the slide rails 338.

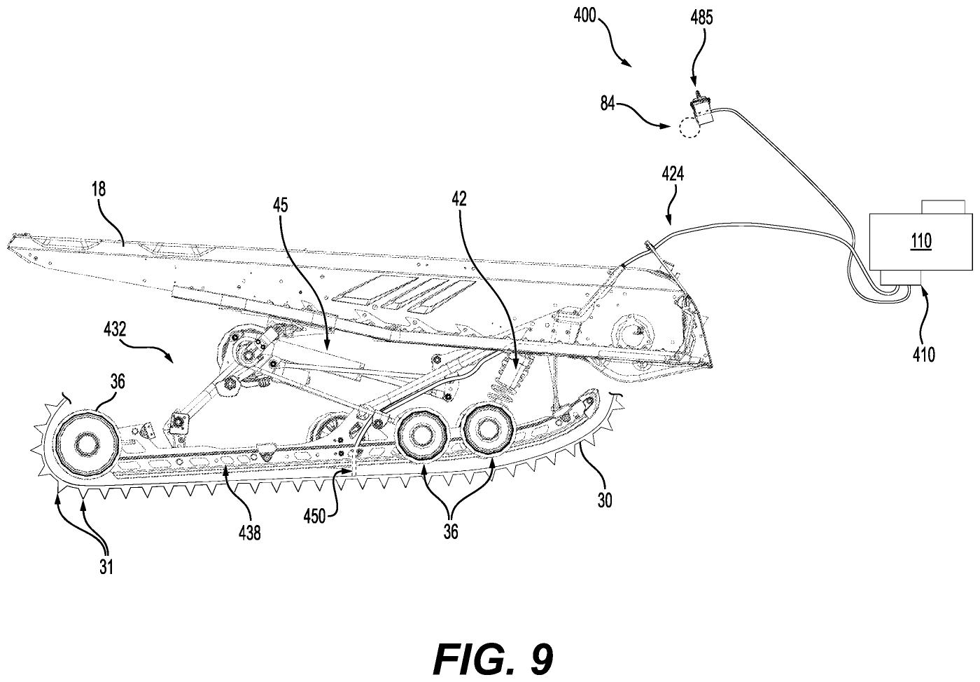

With reference to FIG. 9, yet another embodiment of a track lubricant system 400 and a suspension assembly 432 are illustrated. Elements of the track lubricant system 400 and the suspension assembly 432 that are similar to those of the track lubricant system 100 and the suspension assembly 32 retain the same reference numeral and will generally not be described again.

The suspension assembly 432 includes two slide rails 438 (only the right slide rail 438 being shown). The slide rails 438 each have a lubricant passage 450 defined in an intermediate portion thereof. In different embodiments, the exact positioning of the passage 450 could vary. It is contemplated that one or more passages could be defined in rearward portions of the slide rails 438 additionally or alternatively. The slide rails 438 are otherwise similar to the slide rails 38.

The drive track lubrication system 400 includes an electric pump 410 fluidly connected to the lubricant tank 110. A conduit 424 is fluidly connected to the pump 410 for receiving lubricant therefrom at a top end. A bottom end of the conduit 424 is fluidly connected to the lubricant passage 450 for delivering lubricant thereto, as is described above for the conduits 124, 126, 128 and the passages 150.

The drive track lubrication system 400 also includes a manual lubrication actuator 485, specifically a switch 485, communicatively connected to the pump 410 for selectively actuating the pump 410. The switch 485 is arranged to be accessible to the operator of the vehicle 10 during use, such that the operator may decide to cause the pump 410 to deliver lubricant to the track 30 when the operator determines it is needed. As is illustrated schematically, the switch 485 is disposed on the handlebar 84. It is contemplated that the switch 485 could be disposed elsewhere in different embodiments.

Depending on the embodiment, it is contemplated that the manual actuator 485 could be implemented through various mechanisms, including but not limited to: twist-grip, a push-button, a twist knob, a touchscreen pad, and a toggle switch. It is further contemplated that at least some embodiments of the actuator 485 could include a potentiometer for varying the quantity of lubricant delivered from the tank 110.

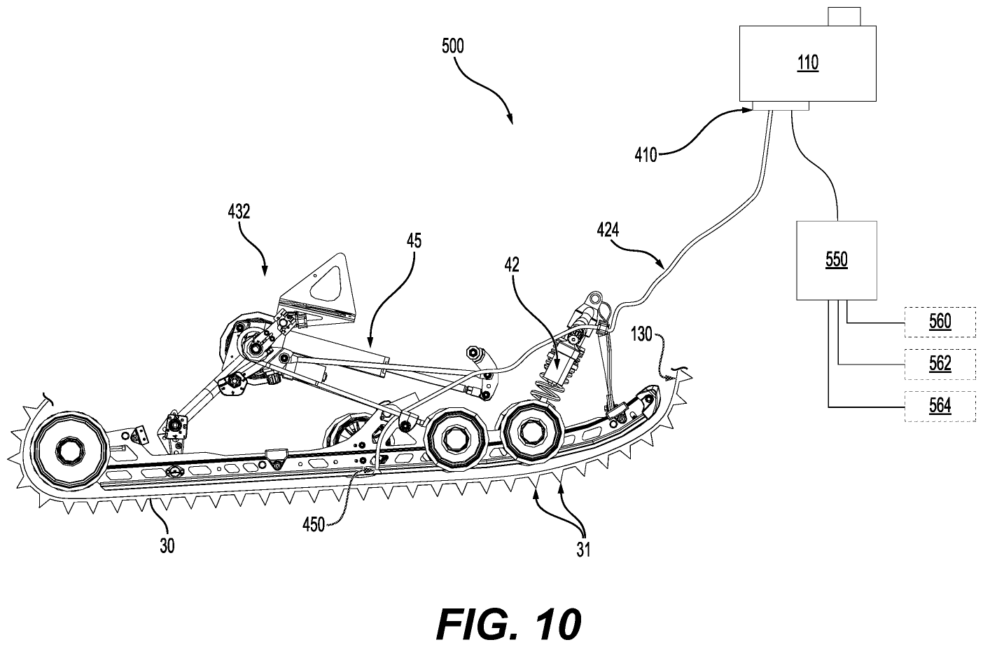

With reference to FIG. 10, yet another embodiment of a track lubrication system 500 is illustrated. Elements of the track lubricant system 500 that are similar to those of the track lubricant systems 100, 400 retain the same reference numeral and will generally not be described again.

The system 500 includes a controller 550 (shown schematically) supported by the chassis 16. While the controller 550 is illustrated as a controller designated for the lubrication system 500, it is contemplated that the controller 550 could be implemented using another computer-implemented device of the snowmobile 10. For example, an engine control unit (ECU, not shown) could be used to implement the controller 550.

The controller 550 is communicatively connected to the pump 410 for controlling operation of the pump 410. The controller 500 is configured to control delivery of lubricant from the lubricant tank 110 to the conduit 424 by the pump 410.

As is schematically illustrated in FIG. 10, the vehicle 10 further includes a plurality of sensors, in at least some embodiments, communicatively connected to the controller 500. The vehicle 10 includes a motor sensor 560 for providing information to the controller 500 related to operations of the motor 26, including but not limited to an output engine torque, fuel injection amount, a throttle opening, a difference between expected vehicle speed and actual vehicle speed, and an engine speed. In embodiments similar to the vehicle 10 with electric motors and batteries, the motor sensor 560, or other sensor connected thereto, could provide information related to power consumption by the electric motor, battery voltage, and/or battery current. The vehicle 10 also includes a speed sensor 562 for determining the vehicle speed during operation of the vehicle 10. In at least some embodiments, the vehicle 10 further includes an orientation sensor 564 (i.e. a pitch, yaw, roll sensor 564) for determining an inclination of the vehicle 10. The sensors 560, 562, 564 are communicatively connected to the controller 500. The controller 500 is then further configured to selectively control delivery of lubricant from the lubricant tank 110 to the conduit 424 by the pump 410 based on information received from one or more of the sensors 560, 562, 564. It is also contemplated that additional sensors could be included, for example an ambient temperature sensor and/or a slide rail temperature sensor.

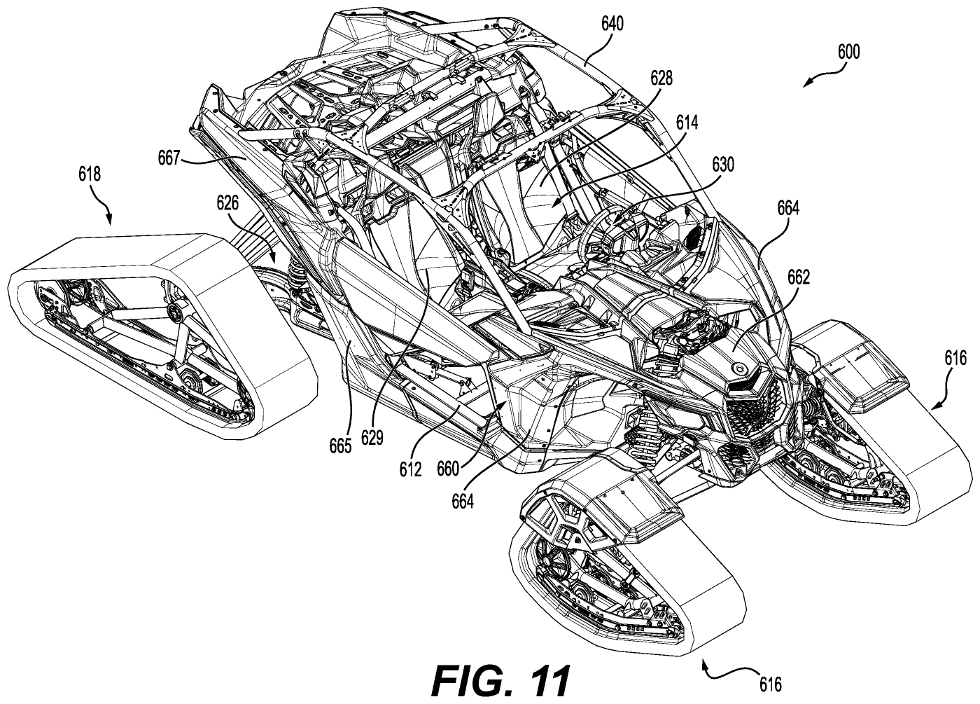

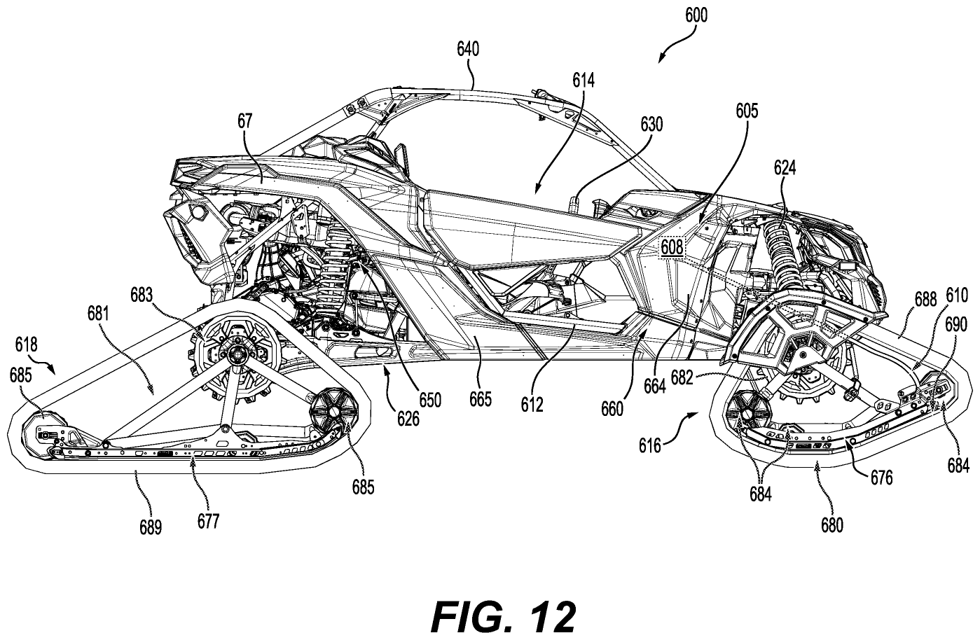

With reference to FIGS. 11 and 12, the present technology will be additionally described with respect to a four-wheel, off-road vehicle 600 having two side-by-side seats and a steering wheel (i.e. a side-by-side vehicle (SSV) 600) equipped with track assemblies. It is also contemplated that aspects of the technology could also be applied to vehicles such as, but not limited to, off-road vehicles having a straddle seat and a handlebar (i.e. an all-terrain vehicle (ATV)) provided with track assemblies. A vehicle similar to the vehicle 600, described briefly herein, is described in more detail in U.S. Patent Publication No. 2020/0339200 A1, published Oct. 29, 2020, the entirety of which is incorporated by reference herein.

The vehicle 600 has a frame 612 defining a central cockpit area 614 inside which are disposed a driver seat 628 and a passenger seat 629. In this embodiment, the driver seat 628 is disposed on the left side of the vehicle 600 and the passenger seat 629 is disposed on the right side of the vehicle 600. However, it is contemplated that the driver seat 628 could be disposed on the right side of the vehicle 600 and that the passenger seat 629 could be disposed on the left side of the vehicle 600. It is also contemplated that the vehicle 600 could include a single seat for the driver, or a larger number of seats, or a bench accommodating the driver and at least one passenger. It is also contemplated that the vehicle 600 could have one or more rows of seats behind the driver and passenger seats 628, 629. The vehicle 600 also includes a roll cage 640 connected to the frame 612 and extending at least partially over the seats 628, 629. The vehicle 600 also includes fairings 660 including a front fascia 662 at the front end of the vehicle 600 and several side panels 664, 665, 667 extending over lateral sides of the vehicle 600.

The vehicle 600 includes left and right front track assemblies 616 connected to the frame 612 by a pair of front suspension assemblies 624, as well as left and right rear track assemblies 618 connected to the frame 612 by a pair of rear suspension assemblies 626. In the present embodiment, the track assemblies 616, 618 are selectively replaceable with ground-engaging wheels. It is contemplated that the vehicle 600 could be constructed with ground-engaging wheel and then replaced with track kits including the track assemblies 616, 618.

The vehicle 600 includes a steering wheel 630 operatively connected to the front track assemblies 616 for controlling an angle of the front track assemblies 616. The driver operates the steering wheel 30 from the driver seat 28. The steering wheel 630 is disposed in front of the driver seat 628. A throttle operator in the form of a throttle pedal (not shown) is disposed over the floor of the cockpit area 614 below the steering wheel 630 and in front of the driver seat 628. A pedal position sensor (not shown) is operatively connected to the throttle pedal to sense movement of the pedal caused by the driver in operation.

As can be seen in FIG. 12, a motor 650 is connected to the frame 612 in a rear portion of the vehicle 600. In the present embodiment, the motor 650 is an internal combustion engine but the present technology is not so limited. It is contemplated that the engine 650 could be replaced by a hybrid or electric motor in some embodiments. The vehicle 600 includes an engine control module (ECM, not shown) for monitoring and controlling various operations of the engine 650.

The motor 650 is connected to a transmission (not shown), specifically a continuously variable transmission (CVT) disposed on a left side of the motor 650. The CVT is operatively connected to a transaxle (not shown) to transmit torque from the motor 650 to the transaxle. The transaxle is operatively connected to the front and rear track assemblies 616, 618 to propel the vehicle 600. The motor 650 and the transmission are supported by the frame 612. Variants of the vehicle 600 having other transmission types are contemplated.

It is contemplated that the illustrated vehicle 600 could be configured differently in other embodiments and is thus not considered to be limiting to the present technology.

The front track assemblies 616 will now be described in more detail. As the left and right front track assemblies 616 are mirror images of one another, only the right front track assembly 616 will be described in detail below. It should be understood that the left front track assembly 616 is configured similarly to the right front track assembly 616.

The front track assembly 616 has a frame 680 and a plurality of track-engaging wheels including a drive wheel 682 and a plurality of idler wheels 684. The drive wheel 682 is laterally centered with respect to the track 688. The track-engaging wheels 682, 684 are rotationally connected to the frame 680. An endless track 688 is disposed around the track-engaging wheels 682, 684, with the wheels 682, 684 defining the path over which the track 688 moves.

The frame 680 further includes two parallel longitudinal slide rails 676 which are laterally spaced from one another and generally equally distanced from opposite lateral edges of the track 688. In at least some embodiments, it is contemplated that the frame 680 could include a single slide rail 676.

The rear track assemblies 618 will now be described in more detail. As the left and right rear track assemblies 618 are mirror images of one another, only the right rear track assembly 618 will be described in detail below. It should be understood that the left rear track assembly 618 is configured similarly to the right rear track assembly 618.

The rear track assembly 618 has a frame 681 and a plurality of track-engaging wheels including a drive wheel 683 and a plurality of idler wheels 685. The track-engaging wheels 683, 685 are rotationally connected to the frame 681. An endless track 689 is disposed around the track-engaging wheels 683, 685, with the wheels 683, 685 defining the path over which the track 689 moves.

The frame 681 further includes two parallel longitudinal slide rails 677 which are laterally spaced from one another and generally equally distanced from opposite lateral edges of the track 689. In at least some embodiments, it is contemplated that the frame 681 could include a single slide rail 677.

It is contemplated that, in other embodiments, the track assembly 616 could be configured differently from that described above. For example, any of the track-engaging wheels 682, 684 and the frame 680 could have any other suitable configuration in other embodiments. Thus, the construction of these components of the track assembly 616 is not considered to be limiting.

The vehicle 600, according to the present technology, further includes a track lubrication system 605, shown schematically in FIG. 12. The track lubrication system 605 selectively provides lubrication to the front tracks 688, specifically between the slide rails 676 and an interior side 690 of the track 688. While only illustrated for the front right track assembly 616, the system 605 is also connected to the front left track assembly 616. In at least some embodiments, the system 605 could additionally or alternatively be arranged to provide selective lubrication to the rear track assemblies 618.

The track lubrication system 605 includes a lubricant tank 608 (shown schematically) supported by the frame 612 for receiving and storing lubricant, as described above with respect to the tank 110. The tank 608 is fluidly connected to a conduit 610. The conduit 610 is arranged to deliver lubricant from the tank 608 to the interior side 690 of the track 688. In the illustrated embodiment, a bottom end (not shown) of the conduit 610 is positioned to deliver lubricant to the track interior side 690, forward of the slide rails 676. Although illustrated by one conduit 610, it is contemplated that a series of fluidly connected conduits could make up the fluid path between the tank 608 and the track 688.

Depending on the particular embodiment, the system 605 could include one or more of the arrangements described above related to the track lubrication systems 100, 200, 300, 400, 500, mutatis mutandis. For example, some embodiments of the system 605 could include a pump and/or actuator for controlling selectively delivery of the lubricant to the tracks 688, similar to the track lubrication system 400. As another non-limiting example, different embodiments of the vehicle 600 could include slide rails with lubricant passages defined therein, similar to the slide rails 38.

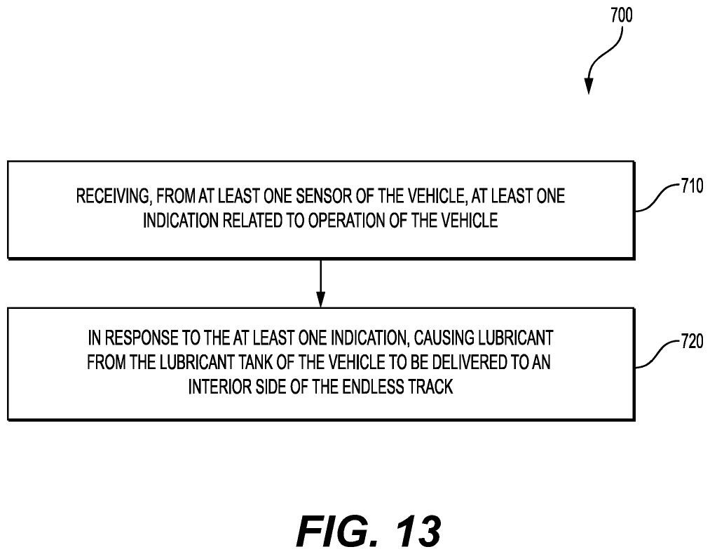

With reference to FIG. 13, a method 700 of operating the track lubrication system 500 in an embodiment of the snowmobile 10 is illustrated. It is contemplated that the method 700 could also be implemented to operate the track lubrication system 605 of the vehicle 600, mutatis mutandis.

The method 700 is performed by the controller 550. In at least some embodiments, it is contemplated that the method 700 could be performed by a different computer-implemented device of the snowmobile 10, such as the ECU.

The method 700 begins, at step 710, with receiving, from one or more of the sensors 560, 562, 564, one or more indications related to operation of the vehicle 10. Depending on the particular embodiment of the vehicle 10 and/or the system 500, the indication related to vehicle operation could include one or more of: receiving an energy consumption indication from the motor sensor 560, receiving an inclination indication from the orientation sensor 564, receiving a speed indication from the speed sensor 562, and determining one or more environmental conditions. Depending on the embodiment, the energy consumption indication could include, but is not limited to, an engine torque, fuel injection amount, a throttle opening, and a difference between expected vehicle speed and actual vehicle speed. It is contemplated that additional information received by or stored to the controller 550 could be accessed by the controller 550.

In at least some embodiments, it is contemplated that the system 500 could further include an actuator, such as the switch 485 of the system 400, communicatively connected to the controller 550. The actuator 485 could then be arranged to receive an activation indication from the user of the vehicle 10, for the user to cause lubricant to be delivered to the track interior surface 130. In some such embodiments, receiving the indication from one of the vehicle sensors could thus include receiving an activation indication from the actuator 485.

The method 700 continues, at step 720, with causing lubricant from the lubricant tank 110 to be delivered to the interior side 130 of the endless track 30, in response to the one or more indications. For example, the controller 550 could cause the pump 110 to deliver lubricant to the track interior side 130 based on the determination that the environmental conditions are likely to increase sticking between the endless track 30.

In at least some embodiments, the method 700 further includes determining, based on the at least one indication, that the endless track 30 has surpassed a threshold sticking indication related to a level of friction between the interior side 130 of the endless track 30 and the slide rails 438 of the vehicle 10. Surpassing the threshold sticking indication could include, for example, determining that the friction or sticking for the track 30 is consuming an excess amount of power or energy from the vehicle 10. As another non-limiting example, determining that the track 30 has surpasses the threshold sticking indication could include determining that a difference between an expected speed (based on motor operations) and an actual vehicle speed is greater than a threshold difference. As another non-limiting example, determining that the track 30 has surpasses the threshold sticking indication could include determining that an instantaneous power consumption of the motor surpasses an expected typical power consumption.

In at least some embodiments, causing the lubricant from the lubricant tank 110 to be delivered to the interior side 130 of the endless track 30 includes causing the pump 410 to pump lubricant through the conduit 424 arranged to deliver lubricant to the interior side 130 of the endless track 30. In some embodiments, it is contemplated that the method 700 could also include causing the pump 410 to deliver lubricant to the track 30 at regular time intervals.

It is contemplated that the method 700 could include additional or different steps, either to perform additional functions and/or to perform the steps described above.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A vehicle, comprising:
a chassis;
at least one seat connected to the chassis;
a motor connected to the chassis;
an endless drive track disposed at least in part below the chassis, the endless drive track being operatively connected to the motor for propulsion of the vehicle;
a suspension assembly supporting the endless drive track, the suspension assembly comprising:
a left slide rail;
a right slide rail;
at least one suspension arm pivotally connected to one of the left and right slide rails and pivotally connected to the chassis;
a shock absorber connected between the chassis and the one of the left and right slide rails; and
a drive track lubrication system connected to the chassis, the system comprising:
a lubricant tank supported by the chassis; and
at least one conduit fluidly connected to the lubricant tank at a first end, a second end of the at least one conduit being positioned and arranged to deliver lubricant from the lubricant tank to at least a portion of an interior side of the endless drive track,
the lubricant delivered providing lubrication at least partially between the interior side of the endless drive track and the left and right slide rails.

2. The vehicle of claim 1, wherein:
at least one slide rail of the left slide rail and the right slide rail has at least one lubricant passage defined therethrough;
the second end of the at least one conduit is fluidly connected to a first opening of the at least one lubricant passage; and
a second opening of the at least one lubricant passage is defined on a lower surface of the at least slide rail such that lubricant passing through the at least one lubricant passage is delivered to the interior side of the endless drive track.

3. The vehicle of claim 2, wherein:
the at least one lubricant passage is at least one first lubricant passage and at least one second lubricant passage;
the at least one first lubricant passage is defined in the right slide rail;
the at least one conduit includes at least one first conduit and at least one second conduit;
the at least one first conduit is fluidly connected to the at least one first lubricant passage;
the left slide rail has the at least one second lubricant passage defined therethrough; and
the at least one second conduit is fluidly connected to the at least one second lubricant passage.

4. The vehicle of claim 3, wherein:
the at least one first lubricant passage includes a first forward lubricant passage and a first rearward lubricant passage;
the first rearward lubricant passage is defined in a portion of the right slide rail rearward of the first forward lubricant passage;
the at least one second lubricant passage includes a second forward lubricant passage and a second rearward lubricant passage; and
the second rearward lubricant passage is defined in a portion of the left slide rail rearward of the second forward lubricant passage.

5. The vehicle of claim 2, wherein:
the at least one slide rail further has at least one groove defined in a bottom surface thereof; and
the at least one groove extending at least rearward from and being fluidly connected to the at least one lubricant passage.

6. The vehicle of claim 1, wherein:
the drive track lubrication system further includes a manual lubrication actuator fluidly connected to the lubricant tank; and
the manual lubrication actuator is arranged to be accessible to an operator of the vehicle during use.

7. The vehicle of claim 6, further comprising a handlebar connected to the chassis; and
wherein:
the manual lubrication actuator is disposed on the handlebar, and
the manual lubrication actuator includes a bulb pump.

8. The vehicle of claim 6, wherein:
the drive track lubrication system further includes a pump fluidly connected to the lubricant tank and the at least one conduit;
the manual lubrication actuator includes a switch communicatively connected to the pump for selectively actuating the pump; and
the switch is arranged to be accessible to an operator of the vehicle during use.

9. The vehicle of claim 8, further comprising a handlebar connected to the chassis; and
wherein the switch is disposed on the handlebar.

10. The vehicle of claim 1, further comprising a controller supported by the chassis; and
wherein:
the drive track lubrication system further includes a pump fluidly connected to the lubricant tank and the at least one conduit, and
the pump is communicatively connected to the controller, the controller being configured to control delivery of the lubricant from the lubricant tank to the at least one conduit by the pump.

11. The vehicle of claim 10, further comprising at least one sensor communicatively connected to the controller; and
wherein the controller is further configured to control delivery of the lubricant from the lubricant tank to the at least one conduit by the pump based on information from the at least one sensor.

12. The vehicle of claim 1, wherein the chassis includes a tunnel, the rear suspension assembly being connected the tunnel.

13. The vehicle of claim 12, wherein the vehicle is a snowmobile; and
further comprising:
a front right ski connected to a front right portion of the chassis; and
a front left ski connected to a front left portion of the chassis.

14. A vehicle, comprising:
a chassis;
at least one seat connected to the chassis;
a motor connected to the chassis;
at least one endless drive track disposed at least in part below the chassis, the at least one endless drive track being operatively connected to the motor for propulsion of the vehicle;
a suspension assembly supporting the endless drive track, the suspension assembly comprising:
at least one slide rail; and
at least one suspension arm pivotally connected to the at least one slide rail and pivotally connected to the chassis;
a drive track lubrication system connected to the chassis, the system comprising:
a lubricant tank supported by the chassis; and
at least one conduit fluidly connected to the lubricant tank at a first end, a second end of the at least one conduit being positioned and arranged to deliver lubricant from the lubricant tank to at least a portion of an interior side of the at least one endless drive track,
the lubricant delivered providing lubrication at least partially between the interior side of the at least one endless drive track and the at least one slide rail.

15. The vehicle of claim 14, wherein:
the at least one slide rail has at least one lubricant passage defined therethrough;
the second end of the at least one conduit is fluidly connected to a first opening of the at least one lubricant passage; and
a second opening of the at least one lubricant passage is defined on a lower surface of the at least slide rail such that lubricant passing through the at least one lubricant passage is delivered to the interior side of the at least one endless drive track.

16. The vehicle of claim 15, wherein:
the at least one lubricant passage includes a forward lubricant passage and a rearward lubricant passage; and
the rearward lubricant passage is defined in a portion of the at least one slide rail rearward of the forward lubricant passage.

17. The vehicle of claim 15, wherein:
the at least one slide rail further has at least one groove defined in a bottom surface thereof; and
the at least one groove extending at least rearward from and being fluidly connected to the at least one lubricant passage.

18. The vehicle of claim 14, wherein:
the drive track lubrication system further includes a manual lubrication actuator fluidly connected to the lubricant tank; and
the manual lubrication actuator is arranged to be accessible to an operator of the vehicle during use.

19. The vehicle of claim 14, wherein:
the drive track lubrication system further includes a pump fluidly connected to the lubricant tank and the at least one conduit; and
the manual lubrication actuator includes a switch communicatively connected to the pump for selectively actuating the pump.

20. The vehicle of claim 14, further comprising a controller supported by the chassis; and
wherein:
the drive track lubrication system further includes a pump fluidly connected to the lubricant tank and the at least one conduit, and
the pump is communicatively connected to the controller, the controller being configured to control delivery of the lubricant from the lubricant tank to the at least one conduit by the pump.
